(19) United States
(12) Patent Application Publication
(10) Pub. No.: US 2025/0109282 A1
(43) Pub. Date: Apr. 3, 2025

(54) NATURAL RUBBER COMPOSITIONS FOR PNEUMATIC TIRES

(71) Applicant: Bridgestone Corporation, Tokyo (JP)

(72) Inventors: Walter A. SALAMANT, Akron, OH (US); Laura S. KOCSIS, Akron, OH (US); Seth M. MILLER, Wooster, OH (US); Jamie Lynn WHYTE, Kent, OH (US); Vrushali BHAGAT, Cuyahoga Falls, OH (US); Xiaoyu WEI, North Canton, OH (US); Shammi AHMED, Copley, OH (US); Ryota SONE, Tokyo (JP)

(21) Appl. No.: 18/725,797

(22) PCT Filed: Dec. 29, 2022
(86) PCT No.: PCT/US2022/082519

§ 371 Date: Jun. 30, 2024

Related U.S. Application Data
(60) Provisional application No. 63/294,718, filed on Dec. 29, 2021.

(51) Int. Cl. C08L 7/00; B60C 1/00; C08K 3/06; C08K 3/36

(52) U.S. Cl. CPC C08L 7/00; B60C 1/0016; C08K 3/06; C08K 3/36; C08L 2205/025; C08L 2205/03; C08L 2312/02; C08L 2312/08

(57) ABSTRACT

A vulcanizable rubber composition comprising a rubber component including (a) natural rubber, (b) functionalized, synthetic polyisoprene, and (c) optionally a butadiene-based synthetic rubber; a silica filler; and curative.

### FIELD OF THE INVENTION

Embodiments of the present invention are directed toward rubber compositions for pneumatic tires, especially polyisoprene-based rubber formations.

### BACKGROUND OF THE INVENTION

Polyisoprene rubber, such as natural rubber, is often used in the manufacture of components of pneumatic tires. Tire components, such as tire treads, that include relatively high levels of natural rubber are typically characterized by good tensile properties, high tear strength, and impact and wear resistance. One or more of these advantageous properties are believed to derive from the fact that natural rubber undergoes strain-induced crystallization. As a result, natural rubber is advantageously used in relatively significant levels in tire components of heavy vehicles such as, for example, truck tires, bus tires, subway train tires, tractor trailer tires, aircraft tires, agricultural tires, earthmover tires, and other off-the-road (OTR) tires.

### SUMMARY OF THE INVENTION

One or more embodiments of the present invention provide a vulcanizable rubber composition comprising a rubber component including (a) natural rubber, (b) functionalized, synthetic polyisoprene, and (c) optionally a butadiene-based synthetic rubber; a silica filler; and curative.

### DETAILED DESCRIPTION OF ILLUSTRATIVE EMBODIMENTS

Embodiments of the invention are based, at least in part, on the discovery of natural rubber-based, silica-filled vulcanizable composition that is useful for preparing vulcanized rubber components with improved properties. In one or more embodiments, the natural rubber-based, silica-filled vulcanizable compositions include synthetic polyisoprene with silica-interactive functional groups. While silica reinforcement has proven useful in rubber components, particularly tire treads, useful reinforcement requires the use of synthetic polymers adapted to interact with the silica. Natural rubber is not easily modified to react with silica, and therefore natural rubber compositions are typically not reinforced with silica. Moreover, it has been observed that the natural rubber phase separates from most butadiene-based synthetic rubbers, which are often used in conjunction with natural rubber in vulcanizable compositions. These natural rubber domains therefore lack polymer-filler interaction in silica-filled formulations. It has now been observed that synthetic polyisoprene is miscible with the natural rubber domains in these rubber formulations and that synthetic polyisoprene with silica-interactive functionalities imparts polymer-filler interaction to these domains within silica-filled formulations. As a result, the present invention provides silica-filled, natural rubber vulcanizates with unexpectedly improved properties. These unexpected properties not only include those properties realized by polymer-silica interactions, but also include those properties typically obtained from natural rubber, which include at least one of advantageous tensile strength, tear strength, wear resistance, and impact resistance. Embodiments of this invention are therefore directed toward vulcanizates that benefit from an overall balance of these properties including treads for off-the-road radial tires.

### Natural Rubber-Based Vulcanizable Compositions

As indicated above, the vulcanizates of the present invention are prepared from a natural rubber-based vulcanizable composition, which may simply be referred to as a vulcanizable composition. According to one or more embodiments, the natural rubber-based vulcanizable compositions include a vulcanizable rubber component that includes (i) natural rubber, (ii) synthetic polyisoprene having silica-interactive functionalities, and (iii) optionally a synthetic butadiene-based rubber. The vulcanizable compositions also include silica filler and a vulcanizing agent. Still further, the vulcanizable compositions of this invention may also include other ingredients that may be included in useful vulcanizable composition such as, but not limited to, coupling agents to link silica filler and polymer, fillers other than silica, stearic acid, metal compounds, such as zinc oxide or derivatives zinc oxide, processing and/or extender oils, resins, waxes, cure accelerators, scorch inhibitors, antidegradants, antioxidants, and other rubber compounding additives known in the art.

### Vulcanizable Rubber Component

As noted above, the vulcanizable rubber component includes (i) natural rubber, (ii) synthetic polyisoprene having silica-interactive functionalities, and (iii) optionally a synthetic butadiene-based rubber.

In one or more embodiments, the vulcanizable rubber component of the natural rubber-based vulcanizable composition includes greater than 40, in other embodiments greater than 50, and in other embodiments greater than 55 percent by weight of natural rubber, based upon the total weight of the vulcanizable rubber component. In these or other embodiments, the vulcanizable rubber component includes less than 90, in other embodiments less than 80, and in other embodiments less than 75 percent by weight of natural rubber based on the total weight of the vulcanizable rubber component. In one or more embodiments, the vulcanizable rubber component includes from about 40 to about 90, in other embodiments from about 50 to about 80, and in other embodiments from about 55 to about 75 percent by weight of natural rubber based upon the total weight of the vulcanizable rubber component.

In one or more embodiments, the vulcanizable rubber component includes greater than 10, in other embodiments greater than 12, and in other embodiments greater than 15 percent by weight of functionalized synthetic polyisoprene, based upon the total weight of the vulcanizable rubber component. In these or other embodiments, the vulcanizable rubber component includes less than 40, in other embodiments less than 30, and in other embodiments less than 25 percent by weight of functionalized synthetic polyisoprene based on the total weight of the vulcanizable rubber component. In one or more embodiments, the vulcanizable rubber component includes from about 10 to about 40, in other embodiments from about 12 to about 30, and in other embodiments from about 15 to about 25 percent by weight of functionalized synthetic polyisoprene based upon the total weight of the vulcanizable rubber component.

In one or more embodiments, the vulcanizable rubber component includes greater than 5, in other embodiments greater than 10, and in other embodiments greater than 15 percent by weight of synthetic butadiene-based rubber, based upon the total weight of the vulcanizable rubber component. In these or other embodiments, the vulcanizable rubber component includes less than 40, in other embodiments less than 35, and in other embodiments less than 30 percent by weight of synthetic butadiene-based rubber based on the total weight of the vulcanizable rubber component. In one or more embodiments, the vulcanizable rubber component includes from about 0 to about 40, in other embodiments from about 10 to about 35, and in other embodiments from about 15 to about 30 percent by weight of synthetic butadiene-based rubber based upon the total weight of the vulcanizable rubber component.

### Natural Rubber

As those skilled in the art appreciate, natural rubber includes naturally derived polyisoprene, which may also be referred to as natural polyisoprene or natural cis-1,4-polyisoprene. This polymer is found in various trees, shrubs and plants, e.g., Hevea brasiliensis, (i.e., the Amazonian rubber tree), Castilla elastica (i.e., the Panama rubber tree), various Landophia vines (L. kirkii, L. heudelotis, and L. owariensis), various dandelions (i.e., Taraxacum species of plants), and Parthenium argentatum (guayule shrubs).

### Synthetic Functionalized Polyisoprene

In one or more embodiments, the synthetic polyisoprene with a silica-interactive functionality, which may also be referred to as functionalized, synthetic polyisoprene, or simply functionalized IR, includes polymer obtained by the synthetic polymerization of isoprene monomer. In one or more embodiments, the polymer is synthesized by employing anionic polymerization techniques. As will be explained in greater detail below, these techniques produce a reactive polymer that can be end-functionalized be reacting the reactive polymer with a functionalizing agent to thereby impart the polymer with a silica-reactive or interactive group.

The preparation of polymer by employing anionic polymerization techniques is generally known. The key mechanistic features of anionic polymerization have been described in books (e.g., Hsieh, H. L.; Quirk, R. P. Anionic Polymerization: Principles and Practical Applications; Marcel Dekker: New York, 1996) and review articles (e.g., Hadjichristidis, N.; Pitsikalis, M.; Pispas, S.; Iatrou, H.; Chem. Rev. 2001, 101(12), 3747-3792). Anionic initiators may advantageously produce polymer having reactive chain ends (e.g., living polymers) that, prior to quenching, are capable of reacting with additional monomers for further chain growth or reacting with certain functionalizing agents to give functionalized polymers. The polymers having reactive polymer chain ends may simply be referred to as reactive polymers. As those skilled in the art appreciate, these reactive polymers include a reactive chain end, which is believed to be ionic, at which a reaction between a functionalizing agent and the reactive chain end of the polymer can take place, which thereby imparts a functionality or functional group to the polymer chain end, or which may couple multiple polymers together.

The practice of this invention is not limited by the selection of any particular anionic initiators. Exemplary anionic initiators include organolithium compounds. In one or more embodiments, organolithium compounds may include heteroatoms. In these or other embodiments, organolithium compounds may include one or more heterocyclic groups. Types of organolithium compounds include alkyllithium compounds, aryllithium compounds, and cycloalkyllithium compounds. Specific examples of organolithium compounds include ethyllithium, n-propyllithium, isopropyllithium, n-butyllithium, sec-butyllithium, t-butyllithium, n-amyllithium, isoamyllithium, and phenyllithium. Still other anionic initiators include organosodium compounds such as phenylsodium and 2,4,6-trimethylphenylsodium.

Anionic polymerization may be conducted in polar solvents, non-polar solvents, and mixtures thereof. In one or more embodiments, a solvent may be employed as a carrier to either dissolve or suspend the initiator in order to facilitate the delivery of the initiator to the polymerization system.

In one or more embodiments, suitable solvents include those organic compounds that will not undergo polymerization or incorporation into propagating polymer chains during the polymerization of monomer in the presence of catalyst. In one or more embodiments, these organic species are liquid at ambient temperature and pressure. In one or more embodiments, these organic solvents are inert to the catalyst. Exemplary organic solvents include hydrocarbons with a low or relatively low boiling point such as aromatic hydrocarbons, aliphatic hydrocarbons, and cycloaliphatic hydrocarbons. Non-limiting examples of aromatic hydrocarbons include benzene, toluene, xylenes, ethylbenzene, diethylbenzene, and mesitylene. Non-limiting examples of aliphatic hydrocarbons include n-pentane, n-hexane, n-heptane, n-octane, n-nonane, n-decane, isopentane, isohexanes, isopentanes, isooctanes, 2,2-dimethylbutane, petroleum ether, kerosene, and petroleum spirits. And, non-limiting examples of cycloaliphatic hydrocarbons include cyclopentane, cyclohexane, methylcyclopentane, and methylcyclohexane. Mixtures of the above hydrocarbons may also be used. The low-boiling hydrocarbon solvents are typically separated from the polymer upon completion of the polymerization. Other examples of organic solvents include high-boiling hydrocarbons of high molecular weights, such as paraffinic oil, aromatic oil, or other hydrocarbon oils that are commonly used to oil-extend polymers. Since these hydrocarbons are non-volatile, they typically do not require separation and remain incorporated in the polymer.

Anionic polymerization may be conducted in the presence of a catalyst modifier (which may also be referred to as a polar coordinator) or a vinyl modifier. As those skilled in the art appreciate, these compounds modify the vinyl content of the mer units deriving from dienes. Compounds useful as catalyst modifiers include those having an oxygen or nitrogen heteroatom and a non-bonded pair of electrons. Examples include linear and cyclic oligomeric oxolanyl alkanes; dialkyl ethers of mono and oligo alkylene glycols (also known as glyme ethers); “crown” ethers; tertiary amines; linear THF oligomers; and the like. Linear and cyclic oligomeric oxolanyl alkanes are described in U.S. Pat. Nos. 4,429,091 and 9,868,795, which is incorporated herein by reference. Specific examples of compounds useful as modifiers include. Specific examples of compounds useful as randomizers include 2,2-bis(2-oxolanyl)propane (also known as 2,2-ditetrahydrofurylpropane), meso-2,2-diterahydrofurylpropane, DL-2,2,-ditetrahdydrofurlypropane, and mixtures thereof, 1,2-dimethoxyethane, N,N,N′,N′-tetramethylethylenediamine (TMEDA), tetrahydrofuran (THF), 1,2-dipiperidylethane, dipiperidylmethane, hexamethylphosphoramide, N-N′-dimethylpiperazine, diazabicyclooctane, dimethyl ether, diethyl ether, tri-n-butylamine, and mixtures thereof.

The amount of modifier to be employed may depend on various factors such as the desired microstructure of the polymer, the polymerization temperature, as well as the nature of the specific modifier employed. In one or more embodiments, the amount of modifier employed may range between 0.01 and 100 mmol, or in other embodiments from about 0.02 to about 10 mmol, or from about 0.03 to about 0.1 mmol of modifier per mmol of the anionic initiator.

The anionic initiator and the modifier can be introduced to the polymerization system by various methods. In one or more embodiments, the anionic initiator and the modifier may be added separately to the monomer to be polymerized in either a stepwise or simultaneous manner.

As the skilled person will appreciate, polymerization of isoprene monomer, in the presence of an effective amount of initiator, produces a reactive polyisoprene polymer. The introduction of the initiator, the isoprene monomer, and the solvent forms a polymerization mixture in which the reactive polymer is formed. Polymerization within a solvent produces a polymerization mixture in which the polymer product is dissolved or suspended in the solvent. This polymerization mixture may be referred to as a polymer cement.

The amount of the initiator to be employed may depend on the interplay of various factors such as the type of initiator employed, the purity of the ingredients, the polymerization temperature, the polymerization rate and conversion desired, the molecular weight desired, and many other factors. In one or more embodiments, the amount of initiator employed may be expressed as the mmols of initiator per weight of monomer. In one or more embodiments, the initiator loading may be varied from about 0.05 to about 50 mmol, in other embodiments from about 0.1 to about 25 mmol, in still other embodiments from about 0.2 to about 2.5 mmol, and in other embodiments from about 0.4 to about 0.7 mmol of initiator per 100 gram of monomer.

In one or more embodiments, the polymerization may be conducted in any conventional polymerization vessel known in the art. For example, the polymerization can be conducted in a conventional stirred-tank reactor. In one or more embodiments, all of the ingredients used for the polymerization can be combined within a single vessel (e.g., a conventional stirred-tank reactor), and all steps of the polymerization process can be conducted within this vessel. In other embodiments, two or more of the ingredients can be pre-combined in one vessel and then transferred to another vessel where the polymerization of monomer (or at least a major portion thereof) may be conducted. Because various embodiments of the present invention include the use of multiple reactors or reaction zones, the vessel (e.g., tank reactor) in which the polymerization is conducted may be referred to as a first vessel or first reaction zone.

The polymerization can be carried out as a batch process, a continuous process, or a semi-continuous process. In the semi-continuous process, the monomer is intermittently charged as needed to replace that monomer already polymerized. In one or more embodiments, the conditions under which the polymerization proceeds may be controlled to maintain the temperature of the polymerization mixture within a range from about −10° C. to about 200° C., in other embodiments from about 0° C. to about 150° C., and in other embodiments from about 20° C. to about 110° C. In one or more embodiments, the heat of polymerization may be removed by external cooling by a thermally controlled reactor jacket, internal cooling by evaporation and condensation of the monomer through the use of a reflux condenser connected to the reactor, or a combination of the two methods. Also, conditions may be controlled to conduct the polymerization under a pressure of from about 0.1 atmosphere to 50 atmospheres, in other embodiments from about 0.5 atmosphere to about 20 atmospheres, and in other embodiments from about 1 atmosphere to about 10 atmospheres. In one or more embodiments, the pressures at which the polymerization may be carried out include those that ensure that the majority of the monomer is in the liquid phase. In these or other embodiments, the polymerization mixture may be maintained under anaerobic conditions.

### Base Polyisoprene Characteristics

In one or more embodiments, the base polyisoprene polymer, which is the polymer prior to functionalization, may be characterized as follows.

In one or more embodiments, the base polyisoprene may be characterized by a number average molecular weight (Mn), weight average molecular weight (Mw), a peak molecular weight (Mp), and molecular weight distribution (Mw/Mn), which may also be referred to as polydispersity. As those skilled in the art will appreciate, Mn and Mw can be determined by using gel permeation chromatography (GPC) using appropriate calibration standards. For purposes of this specification, GPC measurements employ polystyrene standards and THF as a solvent. Also, unless otherwise specified, the molecular weight refers to the weight of the polymer prior functionalization (which may be referred to as the base polymer) since functionalization can result in polymer coupling or dimerization by, for example, condensation, which will have the effect of doubling the weight of the polymer. Since the weight of the functional unit will not otherwise have an appreciable impact on the polymer molecular weight, the term weight of the functionalized, synthetic polyisoprene will therefore be deemed to be the same as the base polymer without coupling or dimerization, unless otherwise specified.

In one or more embodiments, the base synthetic polyisoprene may be characterized by a peak molecular weight (Mp) of greater than 100 kg/mol, in other embodiments greater than 150 kg/mol, and in other embodiments greater than 200 kg/mol. In these or other embodiments, the base synthetic polyisoprene may be characterized by an Mp of less than 700 kg/mol, in other embodiments less than 600 kg/mol, in other embodiments less than 500 kg/mol, in other embodiments less than 450 kg/mol, in other embodiments less than 400 kg/mol, in other embodiments less than 370 kg/mol, and in other embodiments less than 350 kg/mol. In one or more embodiments, the base synthetic polyisoprene may have an Mp of from about 100 to about 700 kg/mol, in other embodiments from about 150 to about 450 kg/mol, and in other embodiments from about 200 to about 350 kg/mol.

In one or more embodiments, the base polyisoprene may be characterized by a number average molecular weight (Mn) of greater than 100 kg/mol, in other embodiments greater than 150 kg/mol, and in other embodiments greater than 200 kg/mol. In these or other embodiments, the base polyisoprene may be characterized by an Mn of less 700 kg/mol, in other embodiments less than 600 kg/mol, in other embodiments less than 500 kg/mol, in other embodiments less than 450 kg/mol, and in other embodiments less than 400 kg/mol. In one or more embodiments, the base polyisoprene may have an Mn of from about 100 to about 700 kg/mol, in other embodiments from about 150 to about 450 kg/mol, in other embodiments from about 100 to about 350 kg/mol, and in other embodiments from about 200 to about 400 kg/mol.

In one or more embodiments, the base polyisoprene may be characterized by a weight average molecular weight (Mw) of greater than 110 kg/mol, in other embodiments greater than 220 kg/mol, and in other embodiments greater than 330 kg/mol. In these or other embodiments, the base polyisoprene may be characterized by an Mw of less 900 kg/mol, in other embodiments less than 800 kg/mol, in other embodiments less than 700 kg/mol, in other embodiments less than 600 kg/mol, and in other embodiments less than about 550 kg/mol. In one or more embodiments, the base synthetic polyisoprene may have an Mw of from about 110 to about 900 kg/mol, in other embodiments from about 220 to about 700 kg/mol, and in other embodiments from about 330 to about 550 kg/mol.

In one or more embodiments, the base polyisoprene may be characterized by vinyl content, which may be described as the number of unsaturations in the 3,4-microstructure relative to the total unsaturations within the polymer chain. As the skilled person will appreciate, vinyl content can be determined by NMR analysis (e.g. using CDCl3 as a solvent). In one or more embodiments, the base polyisoprene includes greater than 2%, in other embodiments greater than 3%, and in other embodiments greater than 5% vinyl units. In these or other embodiments, the base polyisoprene includes less than 45%, in other embodiments less than 20%, and in other embodiments less than 15% vinyl units. In one or more embodiments, the base polyisoprene includes from about 2 to about 45%, in other embodiments from about 3 to about 30%, and in other embodiments from about 4 to about 20% vinyl units. In one or more embodiments, the balance of the mer units are in the 1,4-cis or 1,4-trans microstructure with the ratio of 1,4-cis to 1,4-trans in the range from about 1:1 to about 3:1, or in other embodiments from about 1:3 to about 2.5:1.

In one or more embodiments, the base polyisoprene may be characterized by its 1,4-cis content and 1,4-trans content. As the skilled person will appreciate, microstructure (e.g. 1,4-cis content and 1,4-trans content) can be determined by NMR analysis (e.g. using CDCl3 as a solvent). In one or more embodiments, the base polyisoprene includes greater than 40%, in other embodiments greater than 55%, and in other embodiments greater than 65% of its units in the cis-1,4 microstructure. In these or other embodiments, the base polyisoprene includes less than 90%, in other embodiments less than 80%, and in other embodiments less than 70% of its units in the cis-1,4 microstructure. In one or more embodiments, the base polyisoprene includes from about 40 to about 90%, in other embodiments from about 45 to about 85%, and in other embodiments from about 50 to about 75% of its units in the cis-1,4 microstructure. In these or other embodiments, the base polyisoprene includes greater than 5%, in other embodiments greater than 10%, and in other embodiments greater than 15% of its units in the trans-1,4 microstructure. In these or other embodiments, the base polyisoprene includes less than 50%, in other embodiments less than 40%, and in other embodiments less than 30% of its units in the trans-1,4 microstructure. In one or more embodiments, the base polyisoprene includes from about 5 to about 50%, in other embodiments from about 10 to about 40%, and in other embodiments from about 15 to about 35% of its units in the cis-1,4 microstructure.

### Polyisoprene Functionalization

As indicated above, following polymerization, the reactive polyisoprene polymer is end functionalized, which may also be referred to as end modified, or simply functionalized or modified. That is, the reactive end of the polymer is reacted with a compound, which may be referred to as a functionalizing agent or modifying agent, that imparts a silica-interactive group onto the terminal end of the polymer. It is believed that the polymer chain end reacts with the functionalizing or modifying agent to provide a residue of the functionalizing agent at the end of the polymer chain. Accordingly, the reaction between the polymer and the functionalizing agent produces a polymer composition including one or more polymer chains that include a terminal group deriving from the functionalizing agent or modifying agent. In one or more embodiments, greater than 50 mol %, in other embodiments greater than 70 mol %, and in other embodiments greater than 90 mol % of the polymer chains within the polymer composition are reactive and capable of being reacted with functionalizing agent. In one or more embodiments, from about 50 to about 100 mol %, in other embodiments from about 60 to about 97 mol %, and in other embodiments from about 70 to about 95 mol % of the polymer chains within the polymer composition include a reactive end capable of reacting with the functionalizing agent.

Practice of the present invention is not limited by the selection of any particular functionalizing agent so long as the functionalizing imparts a silica-interactive functional group to the polymer chain end. In one or more embodiments, the functionalizing agent imparts a hydrolyzable group to the terminal end of the polymer chain. In these or other embodiments, the functionalizing agent is a silicon-containing functionalizing agent.

In one or more embodiments, useful silicon-containing functionalizing agents, which may also be referred to as a siloxane terminating agents, hydrocarbyloxy silane functionalizing agents, or hydrocarbyloxy silane terminating agents, may be defined by the formula:

(R¹)_{4-z-y}Si(R²)y(OR²)_{z}

where R¹ is a halogen atom or a monovalent organic group, each R² is a monovalent organic group, z is an integer from 1 to 4, and y is an integer from 0 to 2. In one embodiments, the halogen atom is chlorine.

In one or more embodiments, the monovalent organic groups include hydrocarbyl groups such as, but not limited to, alkyl, cycloalkyl, alkenyl, cycloalkenyl, aryl, allyl, aralkyl, alkaryl, or alkynyl groups. Hydrocarbyl groups also include substituted hydrocarbyl groups, which refer to hydrocarbyl groups in which one or more hydrogen atoms have been replaced by a substituent such as a hydrocarbyl group. In one or more embodiments, these groups may include from one, or the appropriate minimum number of carbon atoms to form the group, to about 20 carbon atoms. These groups may or may not contain heteroatoms. Suitable heteroatoms include, but not limited to, nitrogen, boron, oxygen, silicon, sulfur, tin, and phosphorus atoms. In one or more embodiments, the cycloalkyl, cycloalkenyl, and aryl groups are non-heterocyclic groups. In these or other embodiments, the substituents forming substituted hydrocarbyl groups are non-heterocyclic groups.

Suitable examples of siloxane terminating agents include tetraalkoxysilanes, alkylalkoxysilanes, arylalkoxysilanes, alkenylalkoxysilanes, and haloalkoxysilanes.

Examples of tetraalkoxysilane compounds include tetramethyl orthosilicate, tetraethyl orthosilicate, tetrapropyl orthosilicate, tetrabutyl orthosilicate, tetra(2-ethylhexyl) orthosilicate, tetraphenyl orthosilicate, and tetratoluyloxysilane.

Examples of alkylalkoxysilane compounds include methyltrimethoxysilane, methyltriethoxysilane, methyltri-n-propoxysilane, methyltri-n-butoxysilane, methyltriphenoxysilane, ethyltrimethoxysilane, ethyltriethoxysilane, ethyltri-n-propoxysilane, ethyltri-n-butoxysilane, ethyltriphenoxysilane, dimethyldimethoxysilane, dimethyldiethoxysilane, dimethyldi-n-propoxysilane, dimethyldi-n-butoxysilane, dimethyldiphenoxysilane, diethyldimethoxysilane, and diphenyldimethoxysilane.

Examples of arylalkoxysilane compounds include phenyltrimethoxysilane, phenyltriethoxysilane, phenyltri-n-propoxysilane, phenyltri-n-butoxysilane, and phenyltriphenoxysilane.

Examples of alkenylalkoxysilane compounds include vinyltrimethoxysilane, vinyltriethoxysilane, vinyltri-n-propoxysilane, vinyltri-n-butoxysilane, vinyltriphenoxysilane, allyltrimethoxysilane, octenyltrimethoxysilane, and divinyldimethoxysilane.

Examples of haloalkoxysilane compounds include trimethoxychlorosilane, triethoxychlorosilane, tri-n-propoxychlorosilane, tri-n-butoxychlorosilane, triphenoxychlorosilane, dimethoxydichlorosilane, diethoxydichlorosilane, di-n-propoxydichlorosilane, diphenoxydichlorosilane, methoxytrichlorosilane, ethoxytrichlorosilane, n-propoxytrichlorosilane, phenoxytrichlorosilane, trimethoxybromosilane, triethoxybromosilane, tri-n-propoxybromosilane, triphenoxybromosilane, dimethoxydibromosilane, diethoxydibromosilane, di-n-propoxydibromosilane, diphenoxydibromosilane, methoxytribromosilane, ethoxytribromosilane, n-propoxytribromosilane, phenoxytribromosilane, trimethoxyiodosilane, triethoxyiodosilane, tri-n-propoxyiodosilane, triphenoxyiodosilane, dimethoxydiiodosilane, di-n-propoxydiiodosilane, diphenoxydiiodosilane, methoxytriiodosilane, ethoxytriiodosilane, n-propoxytriiodosilane, and phenoxytriiodosilane.

Techniques for preparing functionalized polymers by using hydrocarbyloxy silane compounds are set forth in U.S. Pat. Nos. 3,244,664; 6,008,295; 6,228,908; and 4,185,042, which are incorporated herein by reference.

In one or more embodiments, hydrocarbyloxy silane functionalizing agents include imino-containing hydrocarbyloxy silanes that may be defined by the formula:

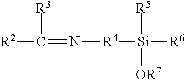

where R², R³, and R⁷ are monovalent organic groups, R⁴ is a divalent organic group, and where R⁵ and R⁶ are each independently hydrocarbyloxy groups or hydrocarbyl groups.

In one or more embodiments, the divalent organic group is a hydrocarbylene groups such as, but not limited to, alkylene, cycloalkylene, alkenylene, cycloalkenylene, alkynylene, cycloalkynylene, or arylene groups. Hydrocarbylene groups include substituted hydrocarbylene groups, which refer to hydrocarbylene groups in which one or more hydrogen atoms have been replaced by a substituent such as a hydrocarbyl group. In one or more embodiments, these groups may include from one, or the appropriate minimum number of carbon atoms to form the group, to about 20 carbon atoms. These groups may or may not contain heteroatoms. Suitable heteroatoms include, but not limited to, nitrogen, boron, oxygen, silicon, sulfur, tin, and phosphorus atoms. In one or more embodiments, the cycloalkylene, cycloalkenylene, and arylene groups are non-heterocyclic groups. In these or other embodiments, the substituents forming substituted hydrocarbylene groups are non-heterocyclic groups.

Examples of these imino-containing hydrocarbyloxy silane compounds include triethoxy compounds such as, but are not limited to, N-(1,3-dimethylbutylidene)-3-(triethoxysilyl)-1-propaneamine, N-(1-methylethylidene)-3-(triethoxysilyl)-1-propaneamine, N-ethylidene-3-(triethoxysilyl)-1-propaneamine, N-(1-methylpropylidene)-3-(triethoxysilyl)-1-propaneamine, N-(4-N,N-dimethylaminobenzylidene)-3-(triethoxysilyl)-1-propaneamine, and N-(cyclohexylidene)-3-(triethoxysilyl)-1-propaneamine. Other examples include trimethoxy compounds such as, but not limited to, N-(1,3-dimethylbutylidene)-3-(trimethoxysilyl)-1-propaneamine, N-(1-methylethylidene)-3-(trimethoxysilyl)-1-propaneamine, N-ethylidene-3-(trimethoxysilyl)-1-propaneamine, N-(1-methylpropylidene)-3-(trimethoxysilyl)-1-propaneamine, N-(4-N,N-dimethylaminobenzylidene)-3-(trimethoxysilyl)-1-propaneamine, and N-(cyclohexylidene)-3-(trimethoxysilyl)-1-propaneamine. Other examples include methyldiethoxy compounds such as, but not limited to, N-(1,3-dimethylbutylidene)-3-(methyldiethoxysilyl)-1-propaneamine, N-(1-methylethylidene)-3-(methyldiethoxysilyl)-1-propaneamine, N-ethylidene-3-(methyldiethoxysilyl)-1-propaneamine, N-(1-methylpropylidene)-3-(methyldiethoxysilyl)-1-propaneamine, N-(4-N,N-dimethylaminobenzylidene)-3-(methyldiethoxysilyl)-1-propaneamine, and N-(cyclohexylidene)-3-(methyldiethoxysilyl)-1-propaneamine. Other examples include ethyldimethoxy compounds such as, but not limited to, N-(1,3-dimethylbutylidene)-3-(ethyldimethoxysilyl)-1-propaneamine, N-(1-methylethylidene)-3-(ethyldimethoxysilyl)-1-propaneamine, N-ethylidene-3-(ethyldimethoxysilyl)-1-propaneamine, N-(1-methylpropylidene)-3-(ethyldimethoxysilyl)-1-propaneamine, N-(4-N,N-dimethylaminobenzylidene)-3-(ethyldimethoxysilyl)-1-propaneamine, and N-(cyclohexylidene)-3-(ethyldimethoxysilyl)-1-propaneamine.

Techniques for preparing functionalized polymers by using imino-containing hydrocarbyloxy compounds are disclosed in U.S. Publication Nos. 2005/0009979; 2010/0113683; and 2011/0092633, which are incorporated herein by reference.

In one or more embodiments, hydrocarbyloxy silane functionalizing agents include hydrocarbyloxy silanes defined by the formula:

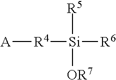

where R⁴ is a divalent organic group, where R⁵ and R⁶ are each independently hydrocarbyloxy groups or hydrocarbyl groups, R⁵ is a monovalent organic group, and A is selected from the group consisting of carboxylic ester, cyclic tertiary amine, non-cyclic tertiary amine, pyridine, silazane, isocyanato, cyano, carboxylic anhydride, epoxy, and sulfide groups.

Examples of hydrocarbyloxy silane compounds including a carboxylic ester group include, but are not limited to, 3-methacryloyloxypropyltriethoxysilane, 3-methacryloyloxypropyltrimethoxysilane, 3-methacryloyloxypropylmethyldiethoxysilane, and 3-methacryloyloxypropyltriisopropoxysilane.

Examples of hydrocarbyloxy silane compounds including a cyclic tertiary amine group include, but are not limited to, 3-(1-hexamethyleneimino)propyltriethoxysilane, 3-(1-hexamethyleneimino)propyltrimethoxysilane, (1-hexamethyleneimino)methyltriethoxysilane, (1-hexamethyleneimino)methyltrimethoxysilane, 2-(1-hexamethyleneimino)ethyltriethoxysilane, 3-(1-hexamethyleneimino)ethyltrimethoxysilane, 3-(1-pyrrolidinyl)propyltrimethoxysilane, 3-(1-pyrrolidinyl)propyltriethoxysilane, 3-(1-heptamethyleneimino)propyltriethoxysilane, 3-(1-dodecamethyleneimino)propyltriethoxysilane, 3-(1-hexamethyleneimino)propyldiethoxyethylsilane, and 3-[10-(triethoxysilyl)decyl]-4-oxazoline

Examples of hydrocarbyloxy silane compounds including a non-cyclic tertiary amine group include, but are not limited to, 3-dimethylaminopropyltriethoxysilane, 3-dimethylaminopropyltrimethoxysilane, 3-diethylaminopropyltrimethoxysilane, 3-diethylaminopropyltriethoxysilane, 2-dimethylaminoethyltriethoxysilane, 2-dimethylaminoethyltrimethoxysilane, 3-dimethylaminopropyldiethoxymethylsilane, 3-diethylaminopropyldiethoxymethylsilane, 3-dimethylaminopropyldimethoxymethylsilane, 3-diethylaminopropyldimethoxymethylsilane, and 3-dibutylaminopropyltriethoxysilane

Examples of hydrocarbyloxy silane compounds including a pyridine group include, but are not limited to, 2-trimethoxysilylethylpyridine.

Examples of hydrocarbyloxy silane compounds including a silazane group include, but are not limited to, N,N-bis(trimethylsilyl)-aminopropylmethyldimethoxysilane, 1-trimethylsilyl-2,2-dimethoxy-1-aza-2-silacyclopentane, N,N-bis(trimethylsilyl)aminopropyltrimethoxysilane, N,N-bis(trimethylsilyl)aminopropyltriethoxysilane, N,N-bis(trimethylsilyl)aminopropylmethyldiethoxysilane, N,N-bis(trimethylsilyl)aminoethyltrimethoxysilane, N,N-bis(trimethylsilyl)aminoethyltriethoxysilane, N,N-bis(trimethylsilyl)aminoethylmethyldimethoxysilane, and N,N-bis(trimethylsilyl)aminoethylmethyldiethoxysilane.

Examples of hydrocarbyloxy silane compounds including an isocyanato group include, but are not limited to, 3-isocyanatopropyltrimethoxysilane, 3-isocyanatopropyltriethoxysilane, 3-isocyanatopropylmethyldiethoxysilane, and 3-isocyanatopropyltriisopropoxysilane.

Examples of hydrocarbyloxy silane compounds including a cyano group include, but are not limited to, 2-cyanoethylpropyltriethoxysilane.

Examples of hydrocarbyloxy silane compounds including a carboxylic anhydride group include, but are not limited to, 3-trimethoxysilylpropylsuccinic anhydride, 3-triethoxysilylpropylsuccinic anhydride, and 3-methyldiethoxysilylpropylsuccinic anhydride.

Examples of hydrocarbyloxy silane compounds including an epoxy group, include, but are not limited to, 2-glycidoxyethyltrimethoxysilane, 2-glycidoxyethyltriethoxysilane, (2-glycidoxyethyl)methyldimethoxysilane, 3-glycidoxypropyltrimethoxysilane, 3-glycidoxypropyltriethoxysilane, (3-glycidoxypropyl)-methyldimethoxysilane, 2-(3,4-epoxycyclohexyl)ethyltrimethoxysilane, 2-(3,4-epoxycyclohexyl)ethyltriethoxysilane, and 2-(3,4-epoxycyclohexyl)ethyl(methyl)dimethoxysilane.

In one or more embodiments, the amount of functionalizing agent employed to prepare the synthetic, functionalized polyisoprene polymers is best described with respect to the equivalents of lithium or metal cation associated with the initiator. For example, the moles of functionalizing agent per mole of lithium may be about 0.1 to about 10, in other embodiments about 0.2 to about 2, in other embodiments about 0.3 to about 3, in other embodiments from about 0.6 to about 1.5, in other embodiments from about 0.7 to about 1.3, in other embodiments from about 0.8 to about 1.1, and in other embodiments from about 0.9 to about 1.0. For purposes of this description, the reaction between the functionalizing agent and the reactive polymer is believed to be nearly quantitative.

In one or more embodiments, the amount of functionalizing agent employed can be described with reference to the amount of polymer to be functionalized. In one or more embodiments, the degree of functionalization is at least 50%, in other embodiments at least 60%, and in other embodiments at least 70% based upon the total number of reactive polymer molecules being treated with the functionalizing agent. In these or other embodiments, the desired degree of functionalization is from about 50 to about 100%, in other embodiments from about 60 to about 95%, and in other embodiments from about 70 to about 90%, based upon the total number of reactive polymer molecules being treated with the functionalizing agent.

In one or more embodiments, the reaction between the functionalizing agent and the reactive polymer may take place at a temperature from about 10° C. to about 150° C., and in other embodiments from about 20° C. to about 100° C. The time required for completing the reaction between the functionalizing agent and the reactive polymer depends on various factors such as the type and amount of the catalyst or initiator used to prepare the reactive polymer, the type and amount of the functionalizing agent, as well as the temperature at which the functionalization reaction is conducted. In one or more embodiments, the reaction between the functionalizing agent and the reactive polymer can be conducted for about 10 to 60 minutes.

### Post Functionalization

In one or more embodiments, after coupling and/or functionalization has been accomplished or completed, a quenching agent can be added to the polymerization mixture in order to inactivate any residual reactive polymer chains and/or initiator residue. In one or more embodiments, the addition of a quenching agent is optional, and therefore in one or more embodiments, a quenching agent is not introduced to the polymerization mixture. The quenching agent may include a protic compound, which includes, but is not limited to, an alcohol, a carboxylic acid, an inorganic acid, water, or a mixture thereof. An antioxidant such as 2,6-di-tert-butyl-4-methylphenol may be added along with, before, or after the addition of the quenching agent. The amount of the antioxidant employed may be in the range of 0.2% to 1% by weight of the polymer product.

In one or more embodiments, the polymer product can be recovered from the polymerization mixture by using any conventional procedures of desolventization and drying that are known in the art. For instance, the polymer can be recovered by subjecting the polymer cement to steam desolventization, followed by drying the resulting polymer crumbs in a hot air tunnel. Alternatively, the polymer may be recovered by directly drying the polymer cement on a drum dryer. The content of the volatile substances in the dried polymer can be below 1%, and in other embodiments below 0.5% by weight of the polymer. In one or more embodiments, after formation of the polymer, a processing aid and other optional additives such as oil can be added to the polymer cement. The polymer and other optional ingredients may then be isolated from the solvent and optionally dried. Conventional procedures for desolventization and drying may be employed. In one embodiment, the polymer may be isolated from the solvent by steam desolventization or hot water coagulation of the solvent followed by filtration. Residual solvent may be removed by using conventional drying techniques such as oven drying or drum drying. Alternatively, the cement may be directly drum dried.

In one or more embodiments, after the introduction of the functionalizing agent to the reactive polymer, optionally after the addition of a quenching agent and/or antioxidant, and optionally after recovery or isolation of the functionalized polymer, a condensation accelerator can be added to the polymerization mixture. Useful condensation accelerators include tin and/or titanium carboxylates and tin and/or titanium alkoxides. One specific example is titanium 2-ethylhexyl oxide. Useful condensation catalysts and their use are disclosed in U.S. Publication No. 2005/0159554A1, which is incorporated herein by reference.

In one or more embodiments, after the reaction between the reactive polymer and the functionalizing agent has been accomplished or completed, optionally after the addition of a quenching agent and/or condensation catalyst, and optionally after recovery or isolation of the functionalized polymer, further reactions may be carried out with the functionalized polymer. For example, the functionalized polymer product can be treated with an alcohol, optionally in the presence of appropriate catalysts, which is believed to affect the formation of hydrocarbyloxy groups in lieu of hydroxy groups or halogen atoms that may be associated with the functional group of the polymer. In these or other embodiments, the functionalized polymers resulting from practice of the present invention can be exposed to or treated with water, optionally in the presence of a catalyst, in order to cleave or replace any hydrolyzable protecting groups that may be present or associated with the functional group of the polymer. Strong acid catalysts, such as those described herein, may be used for this purpose.

The functionalized, synthetic polyisoprene can be characterized by a percent coupling, which a person of skill appreciates can be determined by GPC analysis. In one or more embodiments, the functionalized, synthetic polyisoprene may be characterized by a percent coupling of greater than 50%, in other embodiments greater than 60%, and in other embodiments greater than 70%. In these or other embodiments, the functionalized, synthetic polyisoprene may be characterized by percent coupling of less 90%, in other embodiments less than 85%, and in other embodiments less than 80%. In one or more embodiments, the functionalized, synthetic polyisoprene may be from about 50 to about 90%, in other embodiments from about 55 to about 85%, and in other embodiments from about 60 to about 75% coupled.

The functionalized, synthetic polyisoprene can be characterized by a Mooney viscosity (ML 1+4 @100° C.). In one or more embodiments, the functionalized, synthetic polyisoprene may be characterized by a Mooney viscosity (ML 1+4 @100° C.) of greater than 45, in other embodiments greater than 50, and in other embodiments greater than 55. In these or other embodiments, the functionalized, synthetic polyisoprene may be characterized by Mooney viscosity (ML 1+4 @100° C.) of less than 100, in other embodiments less than 90, and in other embodiments less than 85. In one or more embodiments, the functionalized, synthetic polyisoprene may have a Mooney viscosity (ML 1+4 @100° C.) of from about 45 to about 100, in other embodiments from about 50 to about 90, and in other embodiments from about 55 to about 85.

### Synthetic Butadiene-Based Rubber

In one or more embodiments, the synthetic butadiene-based rubber includes polymer obtained by the synthetic polymerization of 1,3-butadiene, optionally by copolymerizing 1,3-butadiene monomer with other copolymerizable monomer such as other conjugated diene monomer (e.g. isoprene), vinyl-substituted aromatic monomer (e.g. styrene), or ethylene or one or more α-olefins.

Exemplary synthetic butadiene-based polymers include, for example, poly(butadiene), poly(styrene-co-butadiene), poly(butadiene-co-isoprene), and poly(styrene-co-isoprene-co-butadiene). In one or more embodiments, the poly(butadiene) may include high cis-1,4-poly(butadiene), which generally has a cis content greater than 80 mole %, in other embodiments greater than 90 mole %, and in other embodiments greater than 95 mole % units in the cis-1,4-microstructure. In other embodiments, such as where the poly(butadiene) is synthesized by anionic techniques, the poly(butadiene) may be characterized by medium cis content and relatively low vinyl content. In one or more embodiments, the medium cis, low vinyl poly(butadiene) may have a cis content of from about 40 to about 80, in other embodiments from about 45 to about 70, and in other embodiments from about 50 to about 60 mole % units in the cis-1,4-microstructure. In these or other embodiments, the medium cis, low vinyl poly(butadiene) may be characterized by a vinyl content of less than 20 mole %, in other embodiments less than 18 mole %, and in other embodiments less than 15 mole %.

In one or more embodiments, the synthetic butadiene-based polymers are generally high-molecular polymers of the type that are typically used in the construction of tire components. For example, these polymers typically have a base number average molecular weight (i.e. before coupling) of greater than 90 kg/mol, in other embodiments greater than 120 kg/mol, and in other embodiments greater than 150 kg/mol.

In one or more embodiments, the butadiene-based polymer is functionalized. As used herein, a functionalized polymer includes polymers that are modified (i.e. functionalized) with a functionalizing compound that adds or imparts a heteroatom to the polymer chain (e.g. at the chain end). In particular embodiments, these functionalizing agents impart a functional group to the polymer chain to form a functionalized polymer that reduces the 50° C. hysteresis loss of a carbon-black filled vulcanizates prepared from the functionalized polymer as compared to similar carbon-black filled vulcanizates prepared from non-functionalized polymer. In these or other embodiments, the functionalizing agents impart a functional group to the polymer chain to form a functionalized polymer that reduces the 50° C. hysteresis loss of a silica-black filled vulcanizates prepared from the functionalized polymer as compared to similar silica-filled vulcanizates prepared from non-functionalized polymer. In one or more embodiments, the reduction in hysteresis loss (either in carbon black-filled or silica-filled compositions) is at least 5%, in other embodiments at least 10%, and in other embodiments at least 15%.

### Silica Filler

Examples of suitable silica fillers include precipitated amorphous silica, wet silica (hydrated silicic acid), dry silica (anhydrous silicic acid), fumed silica, calcium silicate, aluminum silicate, magnesium silicate, and the like.

In one or more embodiments, silicas may be characterized by their surface areas, which give a measure of their reinforcing character. The Brunauer, Emmet and Teller (“BET”) method (described in J. Am. Chem. Soc., vol. 60, p. 309 et seq.) is a recognized method for determining the surface area. The BET surface area of silica is generally less than 450 m²/g. Useful ranges of surface area include from about 32 to about 400 m²/g, about 100 to about 250 m²/g, and about 150 to about 220 m²/g.

Where one or more silicas is employed, the pH's of the silicas are generally from about 5 to about 7 or slightly over 7, or in other embodiments from about 5.5 to about 6.8.

In one or more embodiments, where silica is employed as a filler (alone or in combination with other fillers), a coupling agent and/or a shielding agent may be added to the rubber compositions during mixing in order to enhance the interaction of silica with the elastomers. Useful coupling agents and shielding agents are disclosed in U.S. Pat. Nos. 3,842,111, 3,873,489, 3,978,103, 3,997,581, 4,002,594, 5,580,919, 5,583,245, 5,663,396, 5,674,932, 5,684,171, 5,684,172, 5,696,197, 6,608,145, 6,667,362, 6,579,949, 6,590,017, 6,525,118, 6,342,552, and 6,683,135, which are incorporated herein by reference. Examples of sulfur-containing silica coupling agents include bis(trialkoxysilylorgano)polysulfides or mercapto-organoalkoxysilanes. Types of bis(trialkoxysilylorgano)polysulfides include bis(trialkoxysilylorgano)disulfide and bis(trialkoxysilylorgano)tetrasulfides.

### Curatives

As suggested above, the vulcanizable compositions of this invention include a cure system. The cure system includes a curative, which may also be referred to as a rubber curing agent or vulcanizing agents. Curing agents are described in Kirk-Othmer, ENCYCLOPEDIA OF CHEMICAL TECHNOLOGY, Vol. 20, pgs. 365-468, (3^{rd} Ed. 1982), particularly Vulcanization Agents and Auxiliary Materials, pgs. 390-402, and A. Y. Coran, Vulcanization, ENCYCLOPEDIA OF POLYMER SCIENCE AND ENGINEERING, (2nd Ed. 1989), which are incorporated herein by reference. In one or more embodiments, useful cure systems include sulfur or sulfur-based curatives. Examples of suitable sulfur vulcanizing agents include “rubbermaker's” soluble sulfur; sulfur donating vulcanizing agents, such as an amine disulfide, polymeric polysulfide or sulfur olefin adducts; and insoluble polymeric sulfur. Vulcanizing agents may be used alone or in combination. The skilled person will be able to readily select the amount of vulcanizing agents to achieve the level of desired cure.

In one or more embodiments, the curative is employed in combination with a cure accelerator. In one or more embodiments, accelerators are used to control the time and/or temperature required for vulcanization and to improve properties of the vulcanizate. Examples of accelerators include thiazole vulcanization accelerators, such as 2-mercaptobenzothiazole, dibenzothiazyl disulfide, N-cyclohexyl-2-benzothiazyl-sulfenamide (CBS), and the like, and guanidine vulcanization accelerators, such as diphenylguanidine (DPG) and the like. The skilled person will be able to readily select the amount of cure accelerators to achieve the level of desired cure.

### Metal Activator and Organic Acid

As suggested above, the vulcanizable compositions of the present invention include a metal compound. In one or more embodiments, the metal compound is an activator (i.e. assists in the vulcanization or cure of the rubber). In other embodiments, the metal activator is a metal oxide. In particular embodiments, the metal activator is a zinc species that is formed in situ through a reaction or interaction between zinc oxide and organic acid (e.g. stearic acid). In other embodiments, the metal compound is a magnesium compound such as magnesium hydroxide. In other embodiments, the metal compound is an iron compound such as an iron oxide. In other embodiments, the metal compound is a cobalt compound such as a cobalt carboxylate. In one or more embodiments, the organic acid is a carboxylic acid. In particular embodiments, the carboxylic acid is a fatty acid including saturated and unsaturated fatty acids. In particular embodiments, saturated fatty acids, such as stearic acid, are employed. Other useful acids include, but are not limited to, palmitic acid, arachidic acid, oleic acid, linoleic acid, and arachidonic acid.

### Silica Coupling Agents

In one or more embodiments, a coupling agent and/or a shielding agent may be added to the vulcanizable rubber compositions. As the skilled person appreciates, coupling agents can enhance the interaction of silica with the functionalized polymers (e.g synthetic functionalized polyisoprene). Useful coupling agents and shielding agents are disclosed in U.S. Pat. Nos. 3,842,111, 3,873,489, 3,978,103, 3,997,581, 4,002,594, 5,580,919, 5,583,245, 5,663,396, 5,674,932, 5,684,171, 5,684,172, 5,696,197, 6,608,145, 6,667,362, 6,579,949, 6,590,017, 6,525,118, 6,342,552, and 6,683,135, which are incorporated herein by reference. Examples of sulfur-containing silica coupling agents include bis(trialkoxysilylorgano)polysulfides or mercapto-organoalkoxysilanes. Types of bis(trialkoxysilylorgano)polysulfides include bis(trialkoxysilylorgano)disulfide and bis(trialkoxysilylorgano)tetrasulfides.

### Carbon Black Filler

As suggested above, the vulcanizable compositions of the invention may include one or more fillers. These filler materials may include reinforcing and non-reinforcing fillers. Exemplary fillers include carbon black, silica, and sundry inorganic fillers.

Useful carbon blacks include furnace blacks, channel blacks, and lamp blacks. More specific examples of carbon blacks include super abrasion furnace blacks, intermediate super abrasion furnace blacks, high abrasion furnace blacks, fast extrusion furnace blacks, fine furnace blacks, semi-reinforcing furnace blacks, medium processing channel blacks, hard processing channel blacks, conducting channel blacks, and acetylene blacks.

In one or more embodiments, the carbon blacks may have a surface area, as defined by an iodine absorption number determined according to ASTM D1510, that is greater than 60 g/kg, in other embodiments greater than 70 g/kg, in other embodiments greater than 80 g/kg, and in other embodiments greater than 90 g/kg. In these or other embodiments, the carbon blacks may have a surface area, as determined by The Brunauer, Emmet and Teller (“BET”) method (described in J. Am. Chem. Soc., vol. 60, p. 309 et seq.), of from about 70 to 200 m²/g, in other embodiments from about 100 to about 180 m²/g, and in other embodiments from about 110 to about 160 m²/g. The carbon blacks may be in a pelletized form or an unpelletized flocculent form. The preferred form of carbon black may depend upon the type of mixing equipment used to mix the rubber compound.

In one or more embodiments, useful carbon blacks may be characterized as an N-300 series or lower carbon blacks according to ASTM D1765. These carbon blacks may include, for example, N-100 series, N-200 series, and N-300 series carbon blacks. Exemplary N-100 series carbon blacks include N-100, N-115, N-120, N-121, N-125, N-134, and N-135 carbon blacks. Exemplary N-200 series carbon blacks may include N-220, N-231, N-294 and N-299. Exemplary N-300 series carbon blacks may include N-326, N-330, N-335, N-343, N-347, N-351, N-356, N-358, and N-375.

### Other Optional Fillers

Other useful filler materials include sundry inorganic and organic fillers. Examples of organic fillers include starch. Examples of inorganic fillers include silica, aluminum hydroxide, magnesium hydroxide, titanium oxides, boron nitrides, iron oxides, mica, talc (hydrated magnesium silicate), and clays (hydrated aluminum silicates).

### Resins

In one or more embodiments, the vulcanizable compositions of the invention may include one or more resins. As the skilled person understands, resins may include plasticizing resins and hardening or thermosetting resins. Useful plasticizing resins include hydrocarbon resins such as cycloaliphatic resins, aliphatic resins, aromatic resins, terpene resins, and combinations thereof. Useful resins are commercially available from various companies including, for example, Chemfax, Dow Chemical Company, Eastman Chemical Company, Idemitsu, Neville Chemical Company, Nippon, Polysat Inc., Resinall Corp., Pinova Inc., Yasuhara Chemical Co., Ltd., Arizona Chemical, and SI Group Inc., and Zeon under various trade names.

In one or more embodiments, useful hydrocarbon resins may be characterized by a glass transition temperature (Tg) of from about 30 to about 160° C., in other embodiments from about 35 to about 60° C., and in other embodiments from about 70 to about 110° C. In one or more embodiments, useful hydrocarbon resins may also be characterized by its softening point being higher than its Tg. In certain embodiments, useful hydrocarbon resins have a softening point of from about 70 to about 160° C., in other embodiments from about 75 to about 120° C., and in other embodiments from about 120 to about 160° C.

In certain embodiments, one or more cycloaliphatic resins are used in combination with one or more of an aliphatic, aromatic, and terpene resins. In one or more embodiments, one or more cycloaliphatic resins are employed as the major weight component (e.g. greater than 50% by weight) relative to total load of resin. For example, the resins employed include at least 55% by weight, in other embodiments at least 80% by weight, and in other embodiments at least 99% by weight of one or more cycloaliphatic resins.

In one or more embodiments, cycloaliphatic resins include both cycloaliphatic homopolymer resins and cycloaliphatic copolymer resins including those deriving from cycloaliphatic monomers, optionally in combination with one or more other (non-cycloaliphatic) monomers, with the majority by weight of all monomers being cycloaliphatic. Non-limiting examples of useful cycloaliphatic resins suitable include cyclopentadiene (“CPD”) homopolymer or copolymer resins, dicyclopentadiene (“DCPD”) homopolymer or copolymer resins, and combinations thereof. Non-limiting examples of cycloaliphatic copolymer resins include CPD/vinyl aromatic copolymer resins, DCPD/vinyl aromatic copolymer resins, CPD/terpene copolymer resins, DCPD/terpene copolymer resins, CPD/aliphatic copolymer resins (e.g. CPD/C5 fraction copolymer resins), DCPD/aliphatic copolymer resins (e.g. DCPD/C5 fraction copolymer resins), CPD/aromatic copolymer resins (e.g. CPD/C9 fraction copolymer resins), DCPD/aromatic copolymer resins (e.g. DCPD/C9 fraction copolymer resins), CPD/aromatic-aliphatic copolymer resins (e.g. CPD/C5 & C9 fraction copolymer resins), DCPD/aromatic-aliphatic copolymer resins (e.g. DCPD/C5 & C9 fraction copolymer resins), CPD/vinyl aromatic copolymer resins (e.g., CPD/styrene copolymer resins), DCPD/vinyl aromatic copolymer resins (e.g. DCPD/styrene copolymer resins), CPD/terpene copolymer resins (e.g. limonene/CPD copolymer resin), and DCPD/terpene copolymer resins (e.g. limonene/DCPD copolymer resins). In certain embodiments, the cycloaliphatic resin may include a hydrogenated form of one of the cycloaliphatic resins discussed above (i.e. a hydrogenated cycloaliphatic resin). In other embodiments, the cycloaliphatic resin excludes any hydrogenated cycloaliphatic resin; in other words, the cycloaliphatic resin is not hydrogenated.

In certain embodiments, one or more aromatic resins are used in combination with one or more of an aliphatic, cycloaliphatic, and terpene resins. In one or more embodiments, one or more aromatic resins are employed as the major weight component (e.g. greater than 50% by weight) relative to total load of resin. For example, the resins employed include at least 55% by weight, in other embodiments at least 80% by weight, and in other embodiments at least 99% by weight of one or more aromatic resins.

In one or more embodiments, aromatic resins include both aromatic homopolymer resins and aromatic copolymer resins including those deriving from one or more aromatic monomers in combination with one or more other (non-aromatic) monomers, with the largest amount of any type of monomer being aromatic. Non-limiting examples of useful aromatic resins include coumarone-indene resins and alkyl-phenol resins, as well as vinyl aromatic homopolymer or copolymer resins, such as those deriving from one or more of the following monomers: alpha-methylstyrene, styrene, ortho-methylstyrene, meta-methylstyrene, para-methylstyrene, vinyltoluene, para(tert-butyl)styrene, methoxystyrene, chlorostyrene, hydroxystyrene, vinylmesitylene, divinylbenzene, vinylnaphthalene or any vinyl aromatic monomer resulting from C9 fraction or C8-C10 fraction. Non-limiting examples of vinylaromatic copolymer resins include vinylaromatic/terpene copolymer resins (e.g. limonene/styrene copolymer resins), vinylaromatic/C5 fraction resins (e.g. C5 fraction/styrene copolymer resin), vinylaromatic/aliphatic copolymer resins (e.g. CPD/styrene copolymer resin, and DCPD/styrene copolymer resin). Non-limiting examples of alkyl-phenol resins include alkylphenol-acetylene resins such as p-tert-butylphenol-acetylene resins, alkylphenol-formaldehyde resins (such as those having a low degree of polymerization. In certain embodiments, the aromatic resin may include a hydrogenated form of one of the aromatic resins discussed above (i.e. a hydrogenated aromatic resin). In other embodiments, the aromatic resin excludes any hydrogenated aromatic resin; in other words, the aromatic resin is not hydrogenated.

In certain embodiments, one or more aliphatic resins are used in combination with one or more of cycloaliphatic, aromatic and terpene resins. In one or more embodiments, one or more aliphatic resins are employed as the major weight component (e.g. greater than 50% by weight) relative to total load of resin. For example, the resins employed include at least 55% by weight, in other embodiments at least 80% by weight, and in other embodiments at least 99% by weight of one or more aliphatic resins.

In one or more embodiments, aliphatic resins include both aliphatic homopolymer resins and aliphatic copolymer resins including those deriving from one or more aliphatic monomers in combination with one or more other (non-aliphatic) monomers, with the largest amount of any type of monomer being aliphatic. Non-limiting examples of useful aliphatic resins include C5 fraction homopolymer or copolymer resins, C5 fraction/C9 fraction copolymer resins, C5 fraction/vinyl aromatic copolymer resins (e.g. C5 fraction/styrene copolymer resin), C5 fraction/cycloaliphatic copolymer resins, C5 fraction/C9 fraction/cycloaliphatic copolymer resins, and combinations thereof. Non-limiting examples of cycloaliphatic monomers include, but are not limited to cyclopentadiene (“CPD”) and dicyclopentadiene (“DCPD”). In certain embodiments, the aliphatic resin may include a hydrogenated form of one of the aliphatic resins discussed above (i.e. a hydrogenated aliphatic resin). In other embodiments, the aliphatic resin excludes any hydrogenated aliphatic resin; in other words, in such embodiments, the aliphatic resin is not hydrogenated.

In one or more embodiments, terpene resins include both terpene homopolymer resins and terpene copolymer resins including those deriving from one or more terpene monomers in combination with one or more other (non-terpene) monomers, with the largest amount of any type of monomer being terpene. Non-limiting examples of useful terpene resins include alpha-pinene resins, beta-pinene resins, limonene resins (e.g. L-limonene, D-limonene, dipentene which is a racemic mixture of L- and D-isomers), beta-phellandrene, delta-3-carene, delta-2-carene, pinene-limonene copolymer resins, terpene-phenol resins, aromatic modified terpene resins and combinations thereof. In certain embodiments, the terpene resin may include a hydrogenated form of one of the terpene resins discussed above (i.e. a hydrogenated terpene resin). In other embodiments, the terpene resin excludes any hydrogenated terpene resin; in other words, in such embodiments, the terpene resin is not hydrogenated.

### Processing Oils

In one or more embodiments, the vulcanizable compositions of this invention include processing oils, which may also be referred to as extender oils. In one or more embodiments, the vulcanizable compositions are devoid or substantially devoid of processing oils.

In particular embodiments, the oils that are employed include those conventionally used as extender oils. Useful oils or extenders that may be employed include, but are not limited to, aromatic oils, paraffinic oils, naphthenic oils, vegetable oils other than castor oils, low PCA oils including MES, TDAE, and SRAE, and heavy naphthenic oils. Suitable low PCA oils also include various plant-sourced oils such as can be harvested from vegetables, nuts, and seeds. Non-limiting examples include, but are not limited to, soy or soybean oil, sunflower oil, safflower oil, corn oil, linseed oil, cotton seed oil, rapeseed oil, cashew oil, sesame oil, camellia oil, jojoba oil, macadamia nut oil, coconut oil, and palm oil. As is generally understood in the art, oils refer to those compounds that have a viscosity that is relatively compared to other constituents of the vulcanizable composition, such as the resins.

In one or more embodiments, oils include those hydrocarbon compounds that have greater than 15, in other embodiments greater than 20, in other embodiments greater than 25, in other embodiments greater than 30 carbon atoms, in other embodiments greater than 35 carbon atoms, and in other embodiments greater than 40 carbon atoms per molecule. In these or other embodiments, oils include those hydrocarbon compounds that have less than 250, in other embodiments less than 200, in other embodiments less than 150, in other embodiments less than 120, in other embodiments less than 100, in other embodiments less than 90, in other embodiments less than 80, in other embodiments less than 70, in other embodiments less than 60, in other embodiments less than 50 carbon atoms per molecule. In one or more embodiments, oils include those hydrocarbon compounds that have from about 15 to about 250, in other embodiments from about 20 to about 200, in other embodiments from about 25 to about 100 carbon atoms per molecule, in other embodiments from about 25 to about 70 carbon atoms per molecule, in other embodiments from about 25 to about 70 carbon atoms per molecule, in other embodiments from about 25 to about 60 carbon atoms per molecule, and in other embodiments from about 25 to about 40 carbon atoms per molecule.

In one or more embodiments, oils include those compounds that have a dynamic viscosity, at 25° C., of greater than 5, in other embodiments greater than 10, in other embodiments greater than 15, in other embodiments greater than 20, in other embodiments greater than 25, and in other embodiments greater than 30, in other embodiments greater than 35, and in other embodiments greater than 40 mPa-s. In these or other embodiments, oils include those compounds that have a dynamic viscosity, at 25° C., less than 3000, in other embodiments less than 2500, in other embodiments less than 2000, in other embodiments less than 1500, in other embodiments less than 1000, in other embodiments less than 750, in other embodiments less than 500, in other embodiments less than 250, in other embodiments less than 100, and in other embodiments less than 75 mPa-s. In one or more embodiments, oils include those compounds that have a dynamic viscosity, at 25° C., from about 5 to about 3000, in other embodiments from about 15 to about 2000, in other embodiments from about 20 to about 1500, in other embodiments from about 25 to about 1000, in other embodiments from about 30 to about 750, in other embodiments from about 35 to about 500, and in other embodiments from about 50 to about 250 mPa-s.

### Other Optional Ingredients

Other ingredients that are typically employed in rubber compounding may also be added to the rubber compositions. These include accelerators, accelerator activators, additional plasticizers, waxes, scorch inhibiting agents, processing aids, zinc oxide, tackifying resins, reinforcing resins, fatty acids such as stearic acid, peptizers, and antidegradants such as antioxidants and antiozonants.

### Ingredient Amounts

### Rubber

As indicated above, the rubber-based vulcanizate compositions include a vulcanizable rubber component. In one or more embodiments, the rubber-based vulcanizable compositions include greater than 20, in other embodiments greater than 30, and in other embodiments greater than 40 percent by weight of the vulcanizable rubber component (which may be simply be referred to as rubber component), based upon the entire weight of the composition. In these or other embodiments, the vulcanizable compositions include less than 90, in other embodiments less than 70, and in other embodiments less than 60 percent by weight of the rubber component based on the entire weight of the vulcanizable composition. In one or more embodiments, the vulcanizable compositions include from about 20 to about 90, in other embodiments from about 30 to about 70, and in other embodiments from about 40 to about 60 percent by weight of the rubber component based upon the entire weight of the vulcanizable composition.

### Filler

In one or more embodiments, the vulcanizable compositions include greater than 0, in other embodiments greater than 10, in other embodiments greater than 25, in other embodiments greater than 35, in other embodiments greater than 45, in other embodiments greater than 55, and in other embodiments greater than 65 parts by weight (pbw) of filler per 100 parts by weight rubber (phr). In these or other embodiments, the vulcanizable composition includes less than 200, in other embodiments less than 150, in other embodiments less than 120, in other embodiments less than 100, in other embodiments less than 80, and in other embodiments less than 70 pbw of filler phr. In one or more embodiments, the vulcanizable composition includes from about 20 to about 100, in other embodiments from about 35 to about 80, and in other embodiments from about 40 to about 70 pbw of filler phr.

### Carbon Black

In one or more embodiments, the vulcanizable compositions include greater than 0, in other embodiments greater than 1, in other embodiments greater than 2, in other embodiments greater than 5, in other embodiments greater than 10, and in other embodiments greater than 15 parts by weight (pbw) of a carbon black per 100 parts by weight rubber (phr). In these or other embodiments, the vulcanizable composition includes less than 60, in other embodiments less than 40, and in other embodiments less than 30 pbw of a carbon black phr. In one or more embodiments, the vulcanizable composition includes from about 1 to about 60, in other embodiments from about 5 to about 50, and in other embodiments from about 10 to about 40 pbw of a carbon black phr. In one or more embodiments, the vulcanizable compositions are devoid or substantially devoid of carbon black.

### Silica

In one or more embodiments, the vulcanizable compositions include greater than 5, in other embodiments greater than 7, in other embodiments greater than 10, in other embodiments greater than 15, and in other embodiments greater than 20 parts by weight (pbw) silica per 100 parts by weight rubber (phr). In these or other embodiments, the vulcanizable composition includes less than 80 pbw, in other embodiments less than 70, in other embodiments less than 60 pbw, in other embodiments less than 50 pbw, and in other embodiments less than 40 pbw of silica phr. In one or more embodiments, the vulcanizable composition includes from about 5 to about 80 pbw, in other embodiments from about 10 to about 60 pbw, and in other embodiments from about 15 to about 40 pbw of silica phr.

### Filler Ratio

In one or more embodiments, the vulcanizable compositions can be characterized by the ratio of silica to other filler compounds such as carbon black. In one or more embodiments, silica is used in excess relative to the other fillers such as carbon black. In one or more embodiments, the ratio of the amount of silica to carbon black, based upon a weight ratio, is greater than 1:1, in other embodiments greater than 1.3:1, in other embodiments greater than 1.5:1, and in other embodiments greater than 2:1. In one or more embodiments, the weight ratio of silica to carbon black is from about 1:1 to about 3:1, in other embodiments from about 1.3: to about 2.5:1, and in other embodiments from about 1.5:1 to about 2:1.

### Silica Coupling Agent

In one or more embodiments, the vulcanizable compositions include greater than 1, in other embodiments greater than 2, and in other embodiments greater than 5 parts by weight (pbw) silica coupling agent per 100 parts by weight silica. In these or other embodiments, the vulcanizable composition includes less than 20, in other embodiments less than 15, and in other embodiments less than 10 pbw of the silica coupling agent per 100 parts by weight silica. In one or more embodiments, the vulcanizable composition includes from about 1 to about 20, in other embodiments from about 2 to about 15, and in other embodiments from about 5 to about 10 pbw of silica coupling agent per 100 parts by weight silica. In one or more embodiments, the vulcanizable compositions are devoid or substantially devoid of silica coupling agents.

### Plasticizing Resin

In one or more embodiments, the vulcanizable compositions include greater than 0.1, in other embodiments greater than 0.5, in other embodiments greater than 1.0, in other embodiments greater than 1.5, in other embodiments greater than 15, and in other embodiments greater than 25 parts by weight (pbw) of plasticizing resin (e.g. hydrocarbon resin) per 100 parts by weight rubber (phr). In these or other embodiments, the vulcanizable composition includes less than 150, in other embodiments less than 120, in other embodiments less than 90, in other embodiments less than 80, in other embodiments less than 60, in other embodiments less than 45, in other embodiments less than 15, in other embodiments less than 10, and in other embodiments less than 3.0 pbw of plasticizing resin (e.g. hydrocarbon resin) phr. In one or more embodiments, the vulcanizable composition includes from about 1 to about 150, in other embodiments from about 0.5 to about 15, in other embodiments from about 1 to about 10, in other embodiments from about 1.5 to about 3, in other embodiments from about 15 to about 100, and in other embodiments from about 25 to about 80 pbw of plasticizing resin (e.g. hydrocarbon resin) phr. In one or more embodiments, the vulcanizable compositions are devoid or substantially devoid of plasticizing resin.

### Processing/Extender Oils

In one or more embodiments, the vulcanizable compositions include greater than 0.1, in other embodiments greater than 0.5, in other embodiments greater than 1, in other embodiments greater than 1.5, and in other embodiments greater than 2 parts by weight (pbw) of a processing oil (e.g. naphthenic oil) per 100 parts by weight rubber (phr). In these or other embodiments, the vulcanizable composition includes less than 20, in other embodiments less than 18, in other embodiments less than 15, in other embodiments less than 12, in other embodiments less than 10, and in other embodiments less than 8, in other embodiments less than 5, and in other embodiments less than 3 pbw of a processing oil phr. In one or more embodiments, the vulcanizable composition includes from about 0.1 to about 20, in other embodiments from about 0.5 to about 18, in other embodiments from about 0.5 to about 15, in other embodiments from about 1 to about 10, in other embodiments from about 0.5 to about 18, in other embodiments from about 1.5 to about 3.0, and in other embodiments from about 2 to about 12 pbw of oil phr. In one or more embodiments, the vulcanizable compositions are devoid or substantially devoid of oils.

### Plasticizing Additives

In one or more embodiments, the plasticizing resin and processing oils may be collectively referred to as plasticizing additives, plasticizing ingredients, plasticizing constituents, or plasticizing system. In one or more embodiments, the vulcanizable compositions of this invention include greater than 0.5, in other embodiments greater than 1, and in other embodiments greater than 1.5 parts by weight (pbw) of plasticizing additives per 100 parts by weight rubber (phr). In these or other embodiments, the vulcanizable composition includes less than 15, in other embodiments less than 12, in other embodiments less than 10, in other embodiments less than 5, and in other embodiments less than 3 pbw of plasticizing additives phr. In one or more embodiments, the vulcanizable composition includes from about 0.5 to about 15, in other embodiments from about 1 to about 10, and in other embodiments from about 1.5 to about 3 pbw of plasticizing additives phr.

### Hardening Resins

In one or more embodiments, the vulcanizable composition includes less than 2, in other embodiments less than 1, in other embodiments less than 0.5 pbw hardening resin phr. In one or more embodiments, the vulcanizable composition includes from about 0.1 to about 8, in other embodiments from about 0.5 to about 6, and in other embodiments from about 2 to about 4 pbw hardening resin phr. In one or more embodiments, the vulcanizable compositions are devoid or substantially hardening resins.

### Sulfur

In one or more embodiments, the vulcanizable compositions include sulfur as the curative. In one or more embodiments, the vulcanizable compositions include greater than 0.1, in other embodiments greater than 0.3, and in other embodiments greater than 0.9 parts by weight (pbw) of sulfur per 100 parts by weight rubber (phr). In these or other embodiments, the vulcanizable compositions includes less than 6, in other embodiments less than 4, in other embodiments less than 3.0, and in other embodiments less than 2.0 pbw of sulfur phr. In one or more embodiments, the vulcanizable composition includes from about 0.1 to about 5.0, in other embodiments from about 0.8 to about 2.5, in other embodiments from about 1 to about 2.0, and in other embodiments from about 1.0 to about 1.8 pbw of sulfur phr.

### Process Overview

In one or more embodiments, vulcanizable compositions are prepared by mixing a vulcanizable rubber and filler to form a masterbatch, and then the curative is subsequently added to the masterbatch. The preparation of the masterbatch may take place using one or more sub-mixing steps where, for example, one or more ingredients may be added to the composition sequentially after an initial mixture is prepared by mixing two or more ingredients. Also, using conventional technology, additional ingredients can be added in the preparation of the vulcanizable compositions such as, but not limited to, carbon black, additional fillers, silica, silica coupling agent, silica dispersing agent, processing oils, processing aids such as zinc oxide and fatty acid, and antidegradants such as antioxidants or antiozonants.

### Mixing Conditions

In one or more embodiments, the various constituents of the rubber component (e.g. the natural rubber, the functionalized, synthetic polyisoprene, and the butadiene-based rubber) are introduced to the vulcanizable rubber as an initial ingredient in the formation of a rubber masterbatch, optionally with carbon black and silica filler. As a result, these constituents undergo high shear, high temperature mixing. In one or more embodiments, this masterbatch mixing step takes place at minimum temperatures in excess of 110° C., in other embodiments in excess of 130° C., and in other embodiments in excess of 150° C. In one or more embodiments, high shear, high temperature mixing takes place at a temperature from about 110° C. to about 170° C. In one or more embodiments, the masterbatch mixing step, or one or more sub-steps of the masterbatch mixing step, may be characterized by the peak temperature obtained by the composition during the mixing. This peak temperature may also be referred to as a drop temperature. In one or more embodiments, the peak temperature of the composition during the masterbatch mixing step may be at least 140° C., in other embodiments at least 150° C., and in other embodiments at least 160° C. In these or other embodiments, the peak temperature of the composition during the masterbatch mixing step may be from about 140 to about 200° C., in other embodiments from about 150 to about 190° C., and in other embodiments from about 160 to about 180° C.

Following the initial mixing, the composition (i.e. masterbatch) is cooled to a temperature of less than 100° C., or in other embodiments less than 80° C., and a curative is added. In certain embodiments, mixing is continued at a temperature of from about 90 to about 110° C., or in other embodiments from about 95 to about 105° C., to prepare the final vulcanizable composition. Following the masterbatch mixing step, a curative or curative system is introduced to the composition and mixing is continued to ultimately form the vulcanizable composition of matter. This mixing step may be referred to as the final mixing step, the curative mixing step, or the productive mixing step. The resultant product from this mixing step may be referred to as the vulcanizable composition.

In one or more embodiments, the final mixing step may be characterized by the peak temperature obtained by the composition during final mixing. As the skilled person will recognize, this temperature may also be referred to as the final drop temperature. In one or more embodiments, the peak temperature of the composition during final mixing may be at most 130° C., in other embodiments at most 110° C., and in other embodiments at most 100° C. In these or other embodiments, the peak temperature of the composition during final mixing may be from about 80 to about 130° C., in other embodiments from about 90 to about 115° C., and in other embodiments from about 95 to about 105° C.

### Mixing Equipment

All ingredients of the vulcanizable compositions can be mixed with standard mixing equipment such as internal mixers (e.g. Banbury or Brabender mixers), extruders, kneaders, and two-rolled mills. Mixing can take place singularly or in tandem. As suggested above, the ingredients can be mixed in a single stage, or in other embodiments in two or more stages. For example, in a first stage (i.e. mixing stage), which typically includes the rubber component and filler, a masterbatch is prepared. Once the masterbatch is prepared, the vulcanizing agents may be introduced and mixed into the masterbatch in a final mixing stage, which is typically conducted at relatively low temperatures so as to reduce the chances of premature vulcanization. Additional mixing stages, sometimes called remills, can be employed between the masterbatch mixing stage and the final mixing stage.

### Preparation of Tire

The vulcanizable compositions can be processed into tire components according to ordinary tire manufacturing techniques including standard rubber shaping, molding and curing techniques. Typically, vulcanization is effected by heating the vulcanizable composition in a mold; e.g. it may be heated to about 140° C. to about 180° C. Cured or crosslinked rubber compositions may be referred to as vulcanizates, which generally contain three-dimensional polymeric networks that are thermoset. The other ingredients, such as fillers and processing aids, may be evenly dispersed throughout the crosslinked network. Pneumatic tires can be made as discussed in U.S. Pat. Nos. 5,866,171, 5,876,527, 5,931,211, and 5,971,046, which are incorporated herein by reference.

### INDUSTRIAL APPLICABILITY

As indicated above, the vulcanizable compositions of the present invention can be cured to prepare various tire components. These tire components include, without limitation, tire treads, tire sidewalls, belt skims, innerliners, ply skims, and bead apex. These tire components can be included within a variety of vehicle tires including passenger tires.

In particular embodiments, the vulcanizates of this invention include one or more components of a heavy vehicle tire, such as a tread or undertread of a heavy vehicle tire. As those skilled in the art appreciate, heavy vehicle tires include, for example, truck tires, bus tires, TBR (truck and bus tires), subway train tires, tractor tires, trailer tires, aircraft tires, agricultural tires, earthmover tires, and other off-the-road (OTR) tires. In one or more embodiments, the heavy vehicle tires may new tires as well as those tires that have been re-treaded. Heavy vehicle tires can sometimes be classified as to their use. For example, truck tires may be classified as drive tires (those that are powered by the truck engine) and steer tires (those that are used to steer the truck). The tires on the trailer of a tractor-trailer rig are also classified separately.

In particular embodiments, heavy vehicle tires are relatively large tires. In one or more embodiments, the heavy vehicle tires have an overall diameter (tread to tread) of greater than 17.5, in other embodiments greater than 20, in other embodiments greater than 25, in other embodiments greater than 30, in other embodiments greater than 40, and in other embodiments greater than 55 inches. In these or other embodiments, heavy vehicle tires have a section width of greater than 10, in other embodiments greater than 11, in other embodiments greater than 12, and in other embodiments great than 14 inches.

In particular embodiments, the heavy vehicle tires are also characterized by their cure times (i.e. the amount of time required to achieve t90). In one or more embodiments, green (i.e. uncured) heavy vehicle tires require a cure time of greater than 30 minutes, in other embodiments greater than 1 hour, in other embodiments greater than 5 hours, in other embodiments greater than 10 hours, and in other embodiments greater than 16 hours (to achieve t90).

### EXAMPLES

In order to demonstrate the practice of the present invention, the following examples have been prepared and tested. The examples should not, however, be viewed as limiting the scope of the invention. The claims will serve to define the invention.

### Samples 1-9

### Preparation of Functionalized, Synthetic Polyisoprene (Triethoxysilane)

Synthetic polyisoprene end-functionalized with a triethyoxy silane was prepared as follows. A 2-gallon stainless steel reaction vessel charged with hexanes (3,801 g) and isoprene (635 g) was treated with n-BuLi (1.30 mL of a 2.45 M solution in hexanes) and 2,2-di(2-tetrahydrofuryl)propane (0.99 mL of a 0.16 M solution in hexanes) immediately followed by increasing the vessel jacket temperature to 50° C. The polymerization reached a peak temperature of 69° C. after 30 minutes from the polymerization start. After 15 minutes from the peak polymerization temperature, 3-(1,3-dimethylbutylidene)aminopropyltriethoxysilane (1.12 mL), which was diluted with ˜20 mL of hexanes, was added to the polymerization mixture. After stirring for an additional 20 minutes, the vessel jacket temperature was reduced to 25° C. and a sample was taken to calculate conversion. Once the batch temperature was below 60° C., the batch was discharged into a solution of isopropyl alcohol (˜16 L) containing 2,5-di-tert-butyl-4-methylphenol (˜1.8 g/L of isopropyl alcohol), coagulated, and then drum dried.

The functionalized polymer (designated IR—Si(OR)3) was analyzed and determined to have a Mn of 243 kg/mol, an Mw of 256 kg/mol, a cis-1,4-microstructure of 75.1 mol %, a trans-1,4-microstructure of 18.6, and a vinyl content of 6.3 mol %. 65% wt % of the polymer was coupled, and the polymer had a Mooney viscosity of 27.9 and a Tg of −62.8° C. Glass transition temperature (Tg) was measured by differential scanning calorimetry (DSC) over the range of −120° C. to 23° C. with a 10° C./min heating rate. The number average (Mn) molecular weight, weight average (Mw) molecular weight, and polydispersity (PDI) were determined by gel permeation chromatography (GPC) using a TOSOH Ecosec HLC-8320 GPC system and TOSOH TSKgel GMHxl-BS columns with THF as a solvent. The system was calibrated using polystyrene (PS) standards and referenced to PS standards. Vinyl microstructure of the isoprene content (3,4-isoprene) was determined by ¹³C NMR to allow for full characterization of the 1,4-cis and 1,4-trans microstructure. Polymer Mooney viscosities were determined using a Monsanto Mooney viscometer. The ML(1+4) values were measured on a large rotor at 100° C. for 4 minutes with a 1 minute warm up time.

### Preparation of Functionalized, Synthetic Polyisoprene (Diethoxysilane)

Synthetic polyisoprene end-functionalized with a diethyoxy silane was prepared as follows. A 2-gallon stainless steel reaction vessel charged with hexanes (3,801 g) and isoprene (635 g) was treated with n-BuLi (1.24 mL of a 2.56 M solution in hexanes) and 2,2-di(2-tetrahydrofuryl)propane (0.10 mL of a 1.6 M solution in hexanes) immediately followed by increasing the vessel jacket temperature to 50° C. The polymerization reached a peak temperature of 61° C. after 55 minutes from the polymerization start. After 15 minutes from the peak polymerization temperature, 3-(1,3-dimethylbutylidene)aminopropylmethyldiethoxysilane (1.07 mL), which was diluted with ˜20 mL of hexanes, was added to the polymerization mixture. After stirring for an additional 30 minutes, the vessel jacket temperature was reduced to 25° C. and a sample was taken to calculate conversion. Once the batch temperature was below 60° C., the batch was discharged into a solution of isopropyl alcohol (˜16 L) containing 2,5-di-tert-butyl-4-methylphenol (˜1.8 g/L of isopropyl alcohol), coagulated, and then drum dried.

The functionalized polymer (designated IR—Si(OR)2) was analyzed and determined to have a Mn of 206 kg/mol, an Mw of 257 kg/mol, a cis-1,4-microstructure of 74.4 mol %, a trans-1,4-microstructure of 17.2, and a vinyl content of 8.4 mol %. 59% wt % of the polymer was coupled, and the polymer had a Mooney viscosity of 35.6 and a Tg of −62.4° C.

### Preparation of Vulcanizates

The functionalized synthetic, polyisoprene prepared above was introduced into a rubber recipe to form a vulcanizable composition that was then vulcanized. The rubber recipe included natural rubber and silica filler as detailed in Tables I and II below. The rubber component of each sample was varied. Generally, the rubber component included natural rubber, an alkoxysilane-terminated polymer, and a functionalized polybutadiene (“Functionalized BR”). The functionalized polybutadiene was a medium-vinyl polybutadiene with a terminal cyclic amine group. Two comparative alkoxysilane-terminated polymers were employed. The first, which is labeled BR—Si(OR)2, was a polybutadiene terminated with 3-(1,3-dimethylbutylidene)aminopropylmethyldiethoxysilane. The polybutadiene had a Mn of 193 kg/mol, an Mw of 205 kg/mol, a cis-1,4-microstructure of 86.1 mol %, a vinyl content of 14 mol %, 69% wt % of the polymer was coupled, and the polymer had a Tg of −91.9° C. The second, which is labeled SBR—Si(OR)3, was a poly(styrene-co-butadiene) end-functionalized with 3-(1,3-dimethylbutylidene)aminopropyltriethoxysilane. The poly(styrene-co-butadiene) had a Mn of 150 kg/mol, an Mw of 164 kg/mol, a styrene content of 34 wt %, a vinyl content of 28.3 mol %, 45% wt % of the polymer was coupled, and had a Tg of −47.8° C.

The vulcanizable compositions were prepared within a 300 g Brabender mixer by using a three stage mix procedure as shown in Table I. The remill did not include that additional of any ingredients. The masterbatch stage was mixed with a starting mixer temperature of 90° C. at 50 rpm and was mixed for 5 minutes or until the sample reached 160° C., whichever occurred first. The remill stage was mixed with a starting mixer temperature of 90° C. at 50 rpm and was mixed for 3.0 minutes or until the sample reached 160° C., whichever occurred first. The final stage was mixed with a starting mixer temperature of 60° C. at 40 rpm and was mixed for 2.5 minutes or until the sample reached 100° C., whichever occurred first.

TABLE I

| | |
|---|---|
| Ingredient | Phr |

Master

| Rubber Component | 100 |
|---|---|
| Carbon Black | 17 |
| Silica | 26 |
| Silane Coupling Agent | 3.9 |
| Stearic Acid | 2 |
| Wax | 1.5 |
| Resin | 1 |
| Antidegradant | 2 |
| Remill | |
| Final | |
| Zinc Oxide | 3.5 |
| Accelerant | 1.41 |
| Sulfur | 1.41 |

The vulcanizable compositions were subjected to Mooney analysis. Samples were cured at 145° C. for 33 minutes. Bound rubber was determined by GPC analysis as described above. Mechanical properties were determined in accordance with ASTM D-412. Dynamic Rheological properties were determined by using both temperature and strain sweep analysis as indicated in Table II. The results of the testing, as well as the specifics of the rubber component, are provided in Table II below. Where the values are indexed, the higher number represents the more desirable property. For example, tan δ @60° C. is desirably a lower number, and therefore the higher index value represents a lower tan δ value.

TABLE II

| Sample | 1 | 2 | 3 | 4 | 5 | 6 | 7 | 8 | 9 |
|---|---|---|---|---|---|---|---|---|---|
| Natural Rubber (phr) | 80 | 64 | 64 | 64 | 64 | 56 | 56 | 56 | 56 |
| Functionalized BR (phr) | 20 | 20 | 20 | 20 | 20 | 20 | 20 | 20 | 20 |
| IR-Si(OR)3 (phr) | — | — | — | 16 | — | — | — | 24 | — |
| IR-Si(OR)2 (phr) | — | — | — | — | 16 | — | — | — | 24 |
| BR-Si(OR)2 (phr) | — | 16 | — | — | — | 24 | — | — | — |
| SBR-Si(OR)3 (phr) | — | — | 16 | — | — | — | 24 | — | — |
| ML(1 + 4) @ 130° C. | 65.7 | 71.8 | 64.2 | 62.7 | 63.3 | 72.4 | 62.6 | 62.2 | 59.1 |
| Bound Rubber (%) | 51% | 46% | 43% | 49% | 47% | 48% | 41% | 50% | 45% |
| M100 (RT) (MPa) | 1.9 | 2.0 | 2.1 | 1.9 | 2.0 | 2.0 | 2.0 | 2.0 | 2.0 |
| M300 (RT) (MPa) | 8.7 | 8.7 | 8.9 | 8.1 | 8.4 | 8.1 | 8.0 | 8.1 | 8.4 |
| M100 (100° C.; aged 100° C.) (MPa) | 1.9 | 2.1 | 2.2 | 1.6 | 1.6 | 2.3 | 2.1 | 2.1 | 2.3 |
| M300 (100° C.; aged 100° C.) (MPa) | 7.1 | 7.7 | 7.8 | 7.0 | 7.0 | 8.2 | 7.5 | 7.5 | 8.2 |
| tanδ Index (Temp Sweep 60° C., 1.9%, 10 Hz) | 100 | 108 | 94 | 156 | 126 | 105 | 87 | 123 | 124 |
| ΔG′ Index (Temp Sweep 60° C., 10 Hz, 0.25-14%) | 100 | 101 | 93 | 116 | 131 | 111 | 86 | 129 | 146 |
| Tanδ Index (Strain Sweep 2%, 60° C., 10 Hz) | 100 | 98 | 84 | 104 | 110 | 99 | 76 | 107 | 110 |

### Samples 10-14

### Preparation of Non-Functionalized Polyisoprene

A non-functionalized, synthetic polyisoprene polymer was prepared as follows. A stainless steel reaction vessel charged with hexanes (9,362 g) and isoprene (1,524 g) was treated with n-BuLi (3.18 mL of a 1.6 M solution in hexanes) and 2,2-di(2-tetrahydrofuryl)propane (0.16 mL of a 1.6 M solution in hexanes) immediately followed by increasing the vessel jacket temperature to 50° C. The polymerization reached a peak temperature of 74° C. after 37 minutes from the polymerization start. After 5 minutes from the peak polymerization temperature, the vessel jacket temperature was reduced to 25° C. After 15 minutes from peak polymerization temperature, a sample was taken to calculate conversion. Once the batch temperature was below 60° C., the batch was discharged into a solution of isopropyl alcohol (˜16 L) containing 2,5-di-tert-butyl-4-methylphenol (˜1.8 g/L of isopropyl alcohol), coagulated, and then drum dried. The polyisoprene polymer, which is designated IR, was characterized by an Mp of 369 kg/mol, a Mooney viscosity (ML 1+4 @100° C.) of 23, and 3,4-vinyl content of 6.4%.

### Preparation of Functionalized, High Molecular Weight Polyisoprene

A high molecular weight synthetic polyisoprene end-functionalized with a triethyoxy silane was prepared as follows. A stainless steel reaction vessel charged with hexanes (9,362 g) and isoprene (1,524 g) was treated with n-BuLi (3.18 mL of a 1.6 M solution in hexanes) and 2,2-di(2-tetrahydrofuryl)propane (0.16 mL of a 1.6 M solution in hexanes) immediately followed by increasing the vessel jacket temperature to 50° C. The polymerization reached a peak temperature of 78° C. after 47 minutes from the polymerization start. After 5 minutes from the peak polymerization temperature, a solution of 3-(1,3-dimethylbutylidene)aminopropyltriethoxysilane (3.2 mL of a 1.6 M solution in hexanes) was added to the reaction. After 12 minutes from the peak polymerization temperature the vessel jacket temperature was reduced to 25° C. and a sample was taken to calculate conversion. Once the batch temperature was below 60° C., the batch was discharged into a solution of isopropyl alcohol (˜16 L) containing 2,5-di-tert-butyl-4-methylphenol (˜1.8 g/L of isopropyl alcohol), coagulated, and then drum dried. The polymer obtained had a higher molecular weight than expected, which was attributed to unintended catalyst demand in the polymerization that reduced the effective loading of n-BuLi initiator. The functionalized polyisoprene polymer, which is designated hMW-IR, was characterized by an Mp of 695 kg/mol, had 52% coupling, a Mooney viscosity (ML 1+4 @100° C.) of 92, and 3,4-vinyl content of 6.5%.

### Preparation of Functionalized, Medium Molecular Weight Polyisoprene

A medium molecular weight synthetic polyisoprene end-functionalized with a triethyoxy silane was prepared as follows. A stainless steel reaction vessel charged with hexanes (9,362 g) and isoprene (1,524 g) was treated with n-BuLi (3.18 mL of a 1.6 M solution in hexanes) and 2,2-di(2-tetrahydrofuryl)propane (0.16 mL of a 1.6 M solution in hexanes) immediately followed by increasing the vessel jacket temperature to 50° C. The polymerization reached a peak temperature of 75° C. after 37 minutes from the polymerization start. Functionalizing agent 3-(1,3-dimethylbutylidene)aminopropyltriethoxysilane (3.2 mL of a 1.6 M solution in hexanes; 1 functionalizing agent/Li) was added to the reaction vessel five minutes after the polymerization reached peak temperature. After 15 minutes from the peak polymerization temperature, the vessel jacket temperature was reduced to 25° C. and a sample was taken to calculate conversion. Once the batch temperature was below 60° C., the batch was discharged into a solution isopropyl alcohol (˜16 L) containing 2,5-di-tert-butyl-4-methylphenol (˜1.8 g/L of isopropyl alcohol), coagulated, and then drum dried. The functionalized polyisoprene polymer, which is designated mMW-IR, was characterized by an Mp of 404 kg/mol, had 71% coupling, a Mooney viscosity (ML 1+4 @100° C.) of 81, and 3,4-vinyl content of 6.5%.

### Preparation of Functionalized, Low Molecular Weight Polyisoprene

A low molecular weight synthetic polyisoprene end-functionalized with a triethyoxy silane was prepared as follows. A stainless steel reaction vessel charged with hexanes (9,362 g) and isoprene (1,524 g) was treated with n-BuLi (3.81 mL of a 1.6 M solution in hexanes) and 2,2-di(2-tetrahydrofuryl)propane (0.19 mL of a 1.6 M solution in hexanes) immediately followed by increasing the vessel jacket temperature to 50° C. The polymerization reached a peak temperature of 75° C. after 36 minutes from the polymerization start. Functionalizing agent 3-(1,3-dimethylbutylidene)aminopropyltriethoxysilane (3.8 mL of a 1.6 M solution in hexanes; 1 functionalizing agent/Li) was added to the reaction vessel five minutes after the polymerization reached peak temperature. After 15 minutes from the peak polymerization temperature, the vessel jacket temperature was reduced to 25° C. and a sample was taken to calculate conversion. Once the batch temperature was below 60° C., the batch was discharged into a solution isopropyl alcohol (˜16 L) containing 2,5-di-tert-butyl-4-methylphenol (˜1.8 g/L of isopropyl alcohol), coagulated, and then drum dried. The functionalized polyisoprene polymer, which is designated 1MW-IR, was characterized by an Mp of 335 kg/mol, had 72% coupling, a Mooney viscosity (ML 1+4 @100° C.) of 63, and 3,4-vinyl content of 6.8%.

### Preparation of Vulcanizates

The synthetic, polyisoprene prepared above (Samples 11-13) were introduced into respective rubber recipes to form vulcanizable compositions that were then vulcanized and tested for various properties. An additional vulcanizate (Sample 10) was prepared without synthetic polyisoprene. The rubber recipe included natural rubber and silica filler as detailed in Tables III and IV below. The rubber component of each sample was varied by including the foregoing polymers as detailed Table IV. As shown, the rubber component of each recipe included natural rubber and a high-cis polybutadiene rubber, which was unfunctionalized and has a cis content in excess of 96%.

The vulcanizable compositions were prepared within a 300 g Brabender mixer by using a three stage mix procedure as shown in Table III. The remill did not include the addition of any ingredients. The masterbatch stage was mixed with a starting mixer temperature of 100° C. at 60 rpm and was mixed for 4.5 minutes or until the sample reached 170° C., whichever occurred first. The remill stage was mixed with a starting mixer temperature of 100° C. at 60 rpm and was mixed for 3.0 minutes or until the sample reached 170° C., whichever occurred first. The final stage was mixed with a starting mixer temperature of 80° C. at 40 rpm and was mixed for 2.5 minutes or until the sample reached 120° C., whichever occurred first.

TABLE III

| | |
|---|---|
| Ingredient | Phr |

Master

| Rubber Component | 100 |
|---|---|
| Carbon Black | 16 |
| Silica | 24 |
| Silane Coupling Agent | 1.92 |
| Stearic Acid | 2 |
| Wax | 1.5 |
| Resin | 1 |
| Antidegradant | 2 |
| Remill | |
| Final | |
| Zinc Oxide | 3.5 |
| Accelerant | 1.6 |
| Sulfur | 1 |

The vulcanizable compositions were subjected to Mooney analysis. Samples were cured at 145° C. for 33 minutes. Bound rubber was determined by GPC analysis as described above. Mechanical properties were determined in accordance with ASTM D-412. Dynamic Rheological properties were determined by using both temperature and strain sweep analysis as indicated in Table IV. The results of the testing, as well as the specifics of the rubber component, are provided in Table IV below.

TABLE IV

| Sample | 10 | 11 | 12 | 13 | 14 |
|---|---|---|---|---|---|
| Natural Rubber (phr) | 70 | 56 | 56 | 56 | 56 |
| High cis Polybutadiene | 30 | 30 | 30 | 30 | 30 |
| IR (phr) | — | 14 | — | — | — |
| hMW-IR (phr) | — | — | 14 | — | — |
| mMW-IR (phr) | — | — | — | 14 | — |
| IMW-IR (phr) | — | — | — | — | 14 |
| ML (1 + 4) @ 130° C. | 75 | 81 | 92 | 92 | 79 |
| Bound Rubber (%) | 55 | 41 | 51 | 52 | 51 |
| M100 (RT) (MPa) | 2.0 | 2.0 | 2.0 | 1.9 | 1.9 |
| M300 (RT) (MPa) | 9.2 | 8.1 | 8.5 | 8.4 | 8.2 |
| M100 (100° C.; | 2.0 | 2.1 | 2.2 | 2.1 | 2.1 |
| aged 100° C.) (MPa) | | | | | |
| M300 (100° C.; | 6.5 | 6.3 | 6.7 | 6.6 | 6.4 |
| aged 100° C.) (MPa) | | | | | |
| tanδ Index (Temp Sweep | 100 | 99 | 105 | 105 | 122 |
| 60° C. 1.9%, 10 Hz) | | | | | |
| ΔG′ Index (Strain Sweep | 100 | 83 | 111 | 126 | 125 |
| 60° C., 10 Hz, 0.1-10%) | | | | | |

Various modifications and alterations that do not depart from the scope and spirit of this invention will become apparent to those skilled in the art. This invention is not to be duly limited to the illustrative embodiments set forth herein.

1. A vulcanizable rubber composition comprising:
(i) a rubber component including (a) natural rubber, (b) functionalized, synthetic polyisoprene, and (c) optionally a butadiene-based synthetic rubber;
(ii) a silica filler; and
(iii) curative.

2. The vulcanizable composition of claim 1, where the rubber component includes natural rubber, functionalized synthetic polyisoprene, and a butadiene-based synthetic rubber.

3. The vulcanizable composition of claim 1, where the vulcanizable composition includes from about 20 to about 90 percent by weight of the rubber component based on the total weight of the vulcanizable rubber composition.

4. The vulcanizable composition of claim 1, where the rubber component includes from about 40 to about 90 percent by weight of the natural rubber, and from about 10 to about 40 percent by weight of the functionalized, synthetic polyisoprene, based on the total weight of the rubber component.

5. (canceled)

6. The vulcanizable composition of claim 1, where the rubber component includes from about 0 to about 40 percent by weight of the butadiene-based synthetic rubber, based on the total weight of the rubber component.

7. The vulcanizable composition of claim 1, where the butadiene-based rubber is poly(butadiene), poly(styrene-co-butadiene), or a combination thereof.

8. The vulcanizable composition of claim 1, where the butadiene-based rubber is a functionalized butadiene-based rubber.

9. The vulcanizable composition of claim 1, where the butadiene-based rubber has a number average molecular weight of greater than 90 kg/mol.

10. The vulcanizable composition of claim 1, where the functionalized, synthetic polyisoprene includes a silica-interactive group.

11. The vulcanizable composition of claim 1, where the functionalized, synthetic polyisoprene includes an alkoxy-silane group.

12. The vulcanizable composition of claim 1, where the functionalized, synthetic polyisoprene is prepared from a synthetic polyisoprene having a base number average molecular weight of from about 100 to about 500 kg/mol.

13. The vulcanizable composition of claim 1, where the functionalized, synthetic polyisoprene is prepared from a synthetic polyisoprene having a base weight average molecular weight of from about 100 to about 600 kg/mol.

14. The vulcanizable composition of claim 1, where the composition is characterized by a t90 of greater than 30 minutes.

15. The vulcanizable composition of claim 1, where the composition includes from about 5 to about 80 parts by weight silica filler per 100 parts by weight of the rubber component.

16. The vulcanizable composition of claim 1, where the vulcanizable composition further includes a silica coupling agent.

17. A vulcanizate prepared from the vulcanizable composition of matter of claim 1.

18. The vulcanizate of claim 17, where the vulcanizate is a component of a heavy vehicle tire.

19. The vulcanizate of claim 17, where the vulcanizate is a tread or undertread of a heavy vehicle tire.

20. The vulcanizate of claim 17, where the heavy vehicle tire is an off-the-road tire.

21. The vulcanizate of claim 17, where the heavy vehicle tire has a diameter of at least 17.5 inches.
